(19) United States
(12) Patent Application Publication
(10) Pub. No.: US 2015/0263877 A1
(43) Pub. Date: Sep. 17, 2015

(54) METHOD AND APPARATUS FOR TRANSMITTING AND RECEIVING PREAMBLE

(71) Applicant: Electronics and Telecommunications Research Institute, Daejeon (KR)

(72) Inventors: Kapseok CHANG, Daejeon (KR); Byung-Jae KWAK, Daejeon (KR)

(21) Appl. No.: 14/645,094

(22) Filed: Mar. 11, 2015

(30) Foreign Application Priority Data
Mar. 11, 2014 (KR) 10-2014-0028072
Mar. 11, 2015 (KR) 10-2015-0033900

(51) Int. Cl. H04L 27/26; H04W 56/00; H04W 28/04; H04L 5/00

(52) U.S. Cl. CPC H04L 27/2646; H04L 5/0007; H04W 56/003; H04L 27/2665; H04W 28/046

(57) ABSTRACT

A method and apparatus for transmitting/receiving a preamble is provided. The apparatus includes an STF and an LTF including a plurality of repetition patterns, a CDF for collision sensing among messages, a CEF for channel estimation, and a CSF for carrier sensing, wherein the time length of the STF equals the time length of two orthogonal frequency division multiplexing (OFDM) symbols.

### CROSS-REFERENCE TO RELATED APPLICATION

This application claims priority to and the benefit of Korean Patent Application Nos. 10-2014-0028072 and 10-2015-0033900 filed in the Korean Intellectual Property Office on Mar. 11, 2014, and Mar. 11, 2015, the entire contents of which are incorporated herein by reference.

### BACKGROUND OF THE INVENTION

(a) Field of the Invention

The present invention relates to a method and apparatus for transmitting/receiving preambles in wireless communication systems.

(b) Description of the Related Art

In the conventional wireless communication system environment, a station terminal is not available to detect a collision of packets that have been received during a preamble estimation procedure. If the station terminal is available to detect a collision of received packets, it may allow the collision to be decreased in a wireless communication system in which resources are allocated based on contention, and accordingly, the system capacity can be increased.

In a case that terminal A transmits packets to terminal B in a wireless communication system (e.g., WLAN) in which communication resources are allocated based on contention, if terminal C transmits packets to terminal B as well since terminal C is unable to perform carrier sensing, a breakdown in communications may occur between terminal A and terminal B. This is referred to as a hidden terminal problem. In this case, the carrier sensing is a function of sensing whether the currently shared medium (e.g., packet) is in use, and signifies that each of the terminals in WLAN should perform a listening operation before transmitting with signals being loaded on a carrier (listen before talk). One of the methods for performing the carrier sensing is a method in which a station terminal detects wireless (radio frequency, RF) energy and determines whether the detected wireless energy exceeds a threshold value. That is, the station terminal may determine that the current medium is being shared if the detected energy is higher than the threshold value, and may determine there is no medium currently shared if the detected energy is lower than the threshold value. If the hidden terminal problem frequently occurs, the capacity of the entire system may be abruptly decreased.

The above information disclosed in this Background section is only for enhancement of understanding of the background of the invention and therefore it may contain information that does not form the prior art that is already known in this country to a person of ordinary skill in the art.

### SUMMARY OF THE INVENTION

An object of the present invention is to provide a method and apparatus for transmitting preambles which can increase performance of synchronization of time/frequency, detect a signal collision, and broaden a range of carrier sensing.

An exemplary embodiment of the present invention provides a method for transmitting a preamble by a terminal. The method includes: transmitting the preamble to a neighboring terminal located around the terminal, wherein the preamble includes a short training field (STF) including five repetition patterns, and a time length of the STF equals a time length of two orthogonal frequency division multiplexing (OFDM) symbols. A polarity of a last repetition pattern among the five repetition patterns may be different from a polarity of remaining four repetition patterns.

The preamble may further include a long training field (LTF) used in fine synchronization, wherein the LTF has a time length that equals a time length of two OFDM symbols, and includes two first valid symbol durations and a first cyclic prefix of the first valid symbol duration, and wherein the first cyclic prefix corresponds to a last ½ of the first valid symbol duration.

The preamble may further include a long training field (LTF) used in fine synchronization, wherein the LTF has a time length that equals a time length of two OFDM symbols, and includes one first valid symbol duration and a first cyclic prefix of the first valid symbol duration, and wherein the first cyclic prefix corresponds to a last ¼ of the first valid symbol duration.

[symbol]

The preamble may further include a long training field (LTF) used in fine synchronization, wherein the LTF includes one first valid symbol duration, and wherein a time length of the first valid symbol duration equals to ⅘ of a time length of the OFDM symbol.

The preamble may further include a collision detection field (CDF) used for collision sensing among messages, wherein the CDF has a time length that equals a time length of an OFDM symbol, and includes one second valid symbol duration and a second cyclic prefix of the second valid symbol duration, and wherein the second cyclic prefix corresponds to a last ¼ of the second valid symbol duration.

The preamble may further include a collision detection field (CDF) used for collision sensing among messages, wherein the CDF includes at least one valid symbol duration, and wherein a time length of the at least one valid symbol duration equals ⅘ of a time length of the OFDM symbol.

The preamble may further include a long training field (LTF) used in fine synchronization and a collision detection field (CDF) used for collision sensing among messages, wherein the LTF is located next to the STF, and wherein the CDF is located next to the LTF.

The preamble may further include a long training field (LTF) used in fine synchronization and a collision detection field (CDF) used for collision sensing among messages, wherein the CDF is located next to the STF, and wherein the LTF is located next to the CDF.

The preamble may further include a channel estimation field (CEF) used for channel estimation, and wherein the CEF is located next to the CDF.

The preamble may further include a channel sensing field (CSF) used for carrier sensing, and wherein the CSF is located at a front part of the STF.

Another exemplary embodiment of the present invention provides a method for receiving a preamble by a terminal. The method includes: receiving a signal from a neighboring terminal located around the terminal; and performing time and frequency synchronization with the signal using a repetition pattern included in a preamble.

The performing the time and frequency synchronization may further include: calculating an auto-correlation value of a conjugate signal of the signal and a previous signal received prior to the signal; and determining an initial time synchronization point based on the auto-correlation value.

The performing the time and frequency synchronization may further include: calculating a first cross-correlation value for a repetition pattern included in the conjugate signal and a short training field (STF) of the preamble; calculating a second cross-correlation value for a repetition pattern included in the conjugate signal and a long training field (LTF) of the preamble; and determining a final time synchronization point by calculating a final correlation value based on the first cross-correlation value and the second cross-correlation value, and based on the final cross-correlation value.

Another exemplary embodiment of the present invention provides a terminal transmitting a preamble. The terminal includes: at least one processor; a memory; and a wireless communication unit, by operating at least one program stored in the memory, wherein the at least one processor performs transmitting the preamble to a neighboring terminal located around the terminal, wherein the preamble includes a short training field (STF) including five repetition patterns, and a time length of the STF equals a time length of two orthogonal frequency division multiplexing (OFDM) symbols.

The preamble may further include a long training field (LTF) used in fine synchronization, wherein the LTF has a time length that equals a time length of two OFDM symbols, and includes two first valid symbol durations and a first cyclic prefix of the first valid symbol duration, and wherein the first cyclic prefix corresponds to a last ½ of the first valid symbol duration.

The preamble may further include a long training field (LTF) used in fine synchronization, wherein the LTF has a time length that equals a time length of two OFDM symbols, and includes one first valid symbol duration and a first cyclic prefix of the first valid symbol duration, and wherein the first cyclic prefix corresponds to a last ¼ of the first valid symbol duration.

The preamble may further include a long training field (LTF) used in fine synchronization, wherein the LTF includes one first valid symbol duration, and wherein a time length of the first valid symbol duration equals ⅘ of a time length of the OFDM symbol.

The preamble may further include a collision detection field (CDF) used for collision sensing among messages, wherein the CDF has a time length that equals a time length of an OFDM symbol, and includes one second valid symbol duration and a second cyclic prefix of the second valid symbol duration, and wherein the second cyclic prefix corresponds to a last ¼ of the second valid symbol duration.

The preamble may further include a long training field (LTF) used in fine synchronization and a collision detection field (CDF) used for collision sensing among messages, wherein the CDF is located next to the STF, and wherein the LTF is located next to the CDF.

### BRIEF DESCRIPTION OF THE DRAWINGS

FIG. 1 is a drawing illustrating an STE included in a preamble of a wireless communication system.

FIG. 2 is a schematic view illustrating a single auto-correlation method.

FIG. 3 is a schematic view illustrating a double auto-correlation method.

FIG. 4 is a drawing illustrating an STF and an LTF included in a preamble.

FIG. 5A and FIG. 5B is a drawing illustrating a preamble according to an exemplary embodiment of the present invention.

FIG. 6 and FIG. 7 are schematic views illustrating a method for estimating time/frequency synchronization according to an exemplary embodiment of the present invention.

FIG. 8 is a drawing illustrating a preamble according to another exemplary embodiment of the present invention.

FIG. 9 is a schematic view illustrating a method for estimating time//frequency synchronization according to another exemplary embodiment of the present invention.

FIG. 10A and FIG. 10B are drawings illustrating a preamble according to another exemplary embodiment of the present invention.

FIG. 11 is a schematic view illustrating a method for estimating time//frequency synchronization according to another exemplary embodiment of the present invention.

FIG. 12A and FIG. 12B are drawings illustrating a preamble according to another exemplary embodiment of the present invention.

FIG. 13A and FIG. 13B are drawings illustrating a preamble according to another exemplary embodiment of the present invention.

FIG. 14A and FIG. 14B are drawings illustrating a preamble according to another exemplary embodiment of the present invention.

FIG. 15A and FIG. 15B are drawings illustrating a preamble according to another exemplary embodiment of the present invention.

FIG. 16A, FIG. 16B, and FIG. 16C are drawings illustrating a method for sensing a preamble and a carrier according to another exemplary embodiment of the present invention.

FIG. 17 is a block diagram illustrating a wireless communication system according to another exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout the specification, a mobile station (MS) may refer to as a terminal, a mobile terminal (MT), an advanced mobile station (AMS), a high reliability mobile station (HR-MS), a subscriber station (SS), a portable subscriber station (PSS), an access terminal (AT), user equipment (UE), etc., and may also include the whole or partial function of the MT, MS, AMS, HR-MS, SS, PSS, AT, UE, etc.

In addition, a base station (BS) may refer to an advanced base station (ABS), a high reliability base station (HR-BS), a node B, an evolved node B (eNodeB), an access point (AP), a radio access station (RAS), a transmitting/receiving base station (base transceiver station, BTS), an MMR (mobile multihop relay)-BS, a relay station (RS) that performs a role of a base station, a relay node (RN) that performs a role of a base station, an advanced repeater (advanced relay station, ARS) that performs a role of a base station, a high reliability relay station (HR-RS) that performs a role of a base station, a small base station [femto base station (femto BS), a home node B (HNB), a home eNodeB (HeNB), a pico base station (pico BS), a metro base station (metro BS), a micro base station (micro BS), etc.], etc., and may include the whole or partial function of the ABS, nodeB, eNodeB, AP, RAS, BTS, MMR-BS, RS, RN, ARS, HR-RS, small base station, etc.

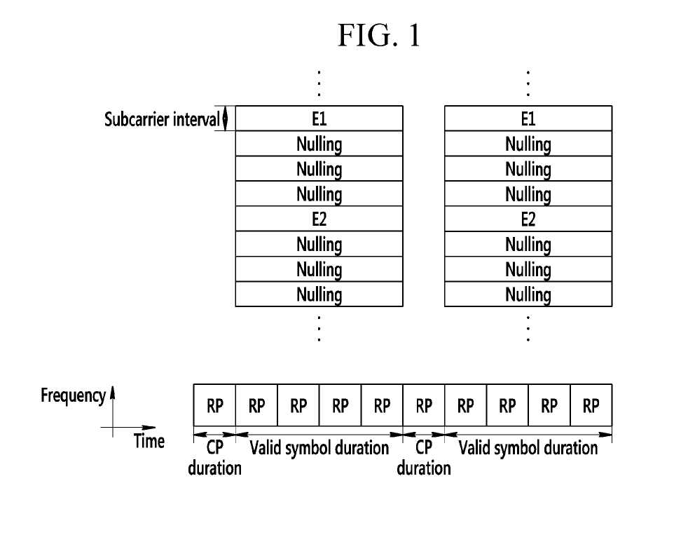

FIG. 1 is a drawing illustrating an STE included in a preamble of a wireless communication system.

FIG. 1 depicts a short training field (STF) included in the preamble of a wireless communication system. Referring to FIG. 1, first, the time length of STF is the same as the time length of two orthogonal frequency division multiplexing (OFDM) symbols. The STF includes two effective symbol durations and two cyclic prefix durations (CP duration), each of the effective symbol durations includes four repetition patterns (RPs), and each of the CP durations includes one RP. That is, five RPs and five time lengths are identical to the time length of an OFDM symbol. Further, referring to a frequency domain, in four RPs included in an effective symbol duration, elements (E1, E3, . . . ) of a frequency domain sequence are allocated to a predetermined subcarrier. In an exemplary embodiment of the present invention, the elements of frequency domain sequence may be allocated in an interval of four subcarriers. Later, an inverse fast Fourier transform (IFFT) may be performed on the elements allocated to each subcarrier. Commonly, in one RP included in the CP interval, the last repetition pattern of the effective symbol duration is copied.

A terminal that receives the preamble may automatically adjust a gain using the STF (automatic gain control) and estimate packets, and estimate initial time/frequency synchronization. At this time, if the terminal performs the automatic gain control using one OFDM symbol of two OFDM symbols included in the STF, the terminal should perform the packet estimation and acquire the initial time/frequency synchronization using the remaining OFDM symbol. Accordingly, since the number of samples included in the repetition pattern may be restricted, the performance of time/frequency synchronization may be deteriorated under a low signal-to-noise ratio (SNR) environment. Since the packet estimation may be performed by a method of determining whether the correlation value of STF exceeds a threshold value in the estimation of common synchronization, an additional packet estimation procedure is not necessarily needed.

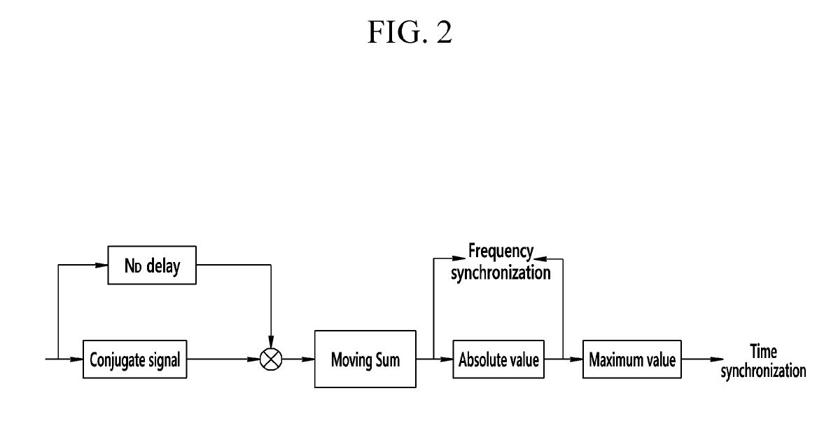

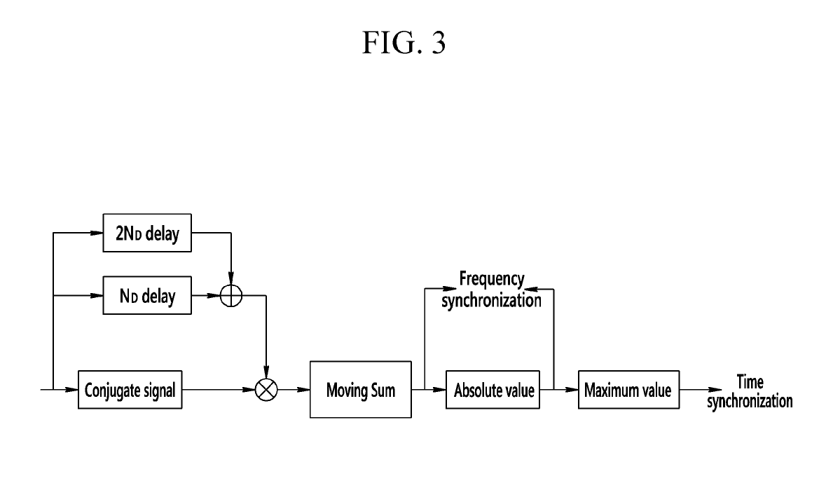

FIG. 2 is a schematic view illustrating a single auto-correlation method, and FIG. 3 is a schematic view illustrating a double auto-correlation method.

Referring to a single auto-correlation method shown in FIG. 2, the correlation procedure among adjacent repetition patterns may be performed as below. A conjugate value of signal x ((x)*) which is previously received (i.e., the conjugate value of a current repetition pattern) and a delay value (Z−^{ND}) (i.e., the previous repetition pattern) which is delayed by as much as an N_{D} sample of the received signal may be multiplied by as much as the number of specific elements. Later, the multiplication of the conjugate value and the delay value are added during a predetermined duration, and the result value R is outputted. Then, by selecting the maximum value among the sample |R| during the predetermined duration based on an absolute value (|R|) of the result value R, an auto-correlation value of the received signal may be determined. t this time, if the number of samples of the repetition pattern is small, the influence caused by noise is increased, and accordingly, correlation characteristics may be deteriorated when the influence of noise becomes greater since the SNR is low under the communication environment. To compensate this, a sequence which has good characteristics in the auto-correlation among adjacent repetition patterns may be used, but this may not be a perfect solution to solve the problem that the influence of noise becomes greater.

The double auto-correlation method shown in FIG. 3 is a method of adding the previous repetition pattern (Z^{-ND}) and the predecessor (Z^{-2ND}) and then multiplying the result by the conjugate ((x)*) of the current repetition pattern in order to decrease the influence of noise. However, in case there is a frequency offset (a difference between carrier frequencies), the double auto-correlation method may deteriorate the synchronization estimation performance due to the phase offset between the auto-correlation functions.

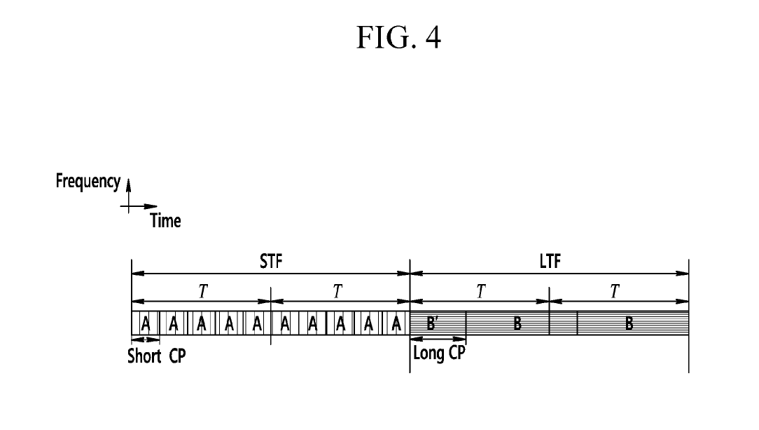

FIG. 4 is a drawing illustrating an STF and an LTF included in a preamble.

Referring to FIG. 4, the time length of STF and LTF is the same as that of two OFDM symbols. The STF includes ten repetition patterns A, and in an exemplary embodiment of the present invention, a first A and a sixth A of the STF may correspond to the CP of valid symbol duration (second-fifth A and seventh-tenth A). The LTF includes two repetition patterns B and B′ which are CPs of the repetition patterns. In an exemplary embodiment of the present invention, the length of the CP included in the STF is T/5, which is referred to as a short CP, and the length of the CP included in the LTF is 2T/5, which is referred to as a long CP.

In the LTF, two valid OFDM symbols are repeated in order to perform the channel estimation and fine time/frequency synchronization, and accordingly, unnecessary resources may be wasted. That is, if it is possible to elaborately estimate the synchronization and channel with one symbol, it prevents two symbols from being unnecessarily wasted. Otherwise, if a terminal may estimate the time synchronization in the CP of STF and also compensate for the frequency offset, the terminal may perform fine estimation even though the terminal uses only one OFDM symbol included in the LTF.

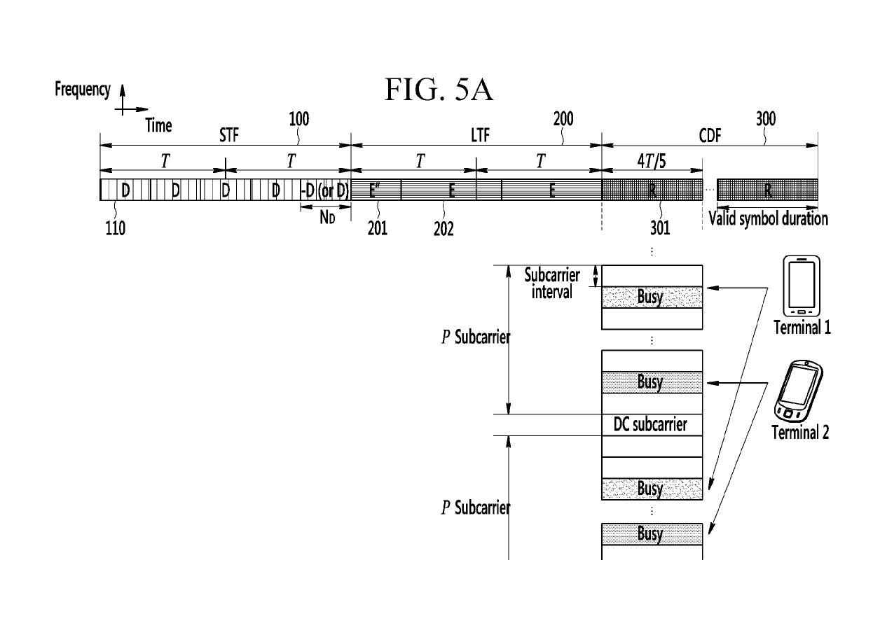

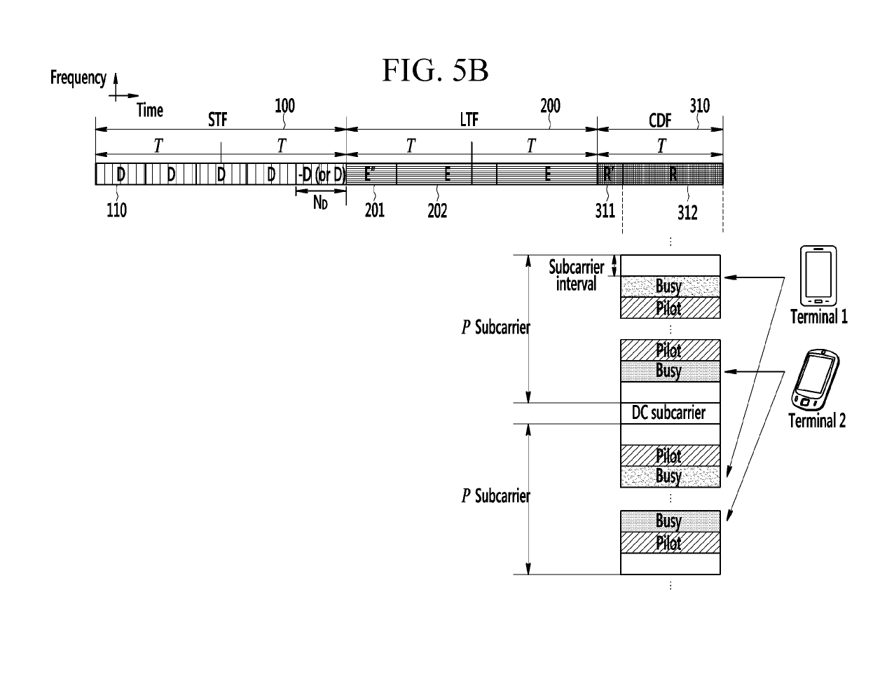

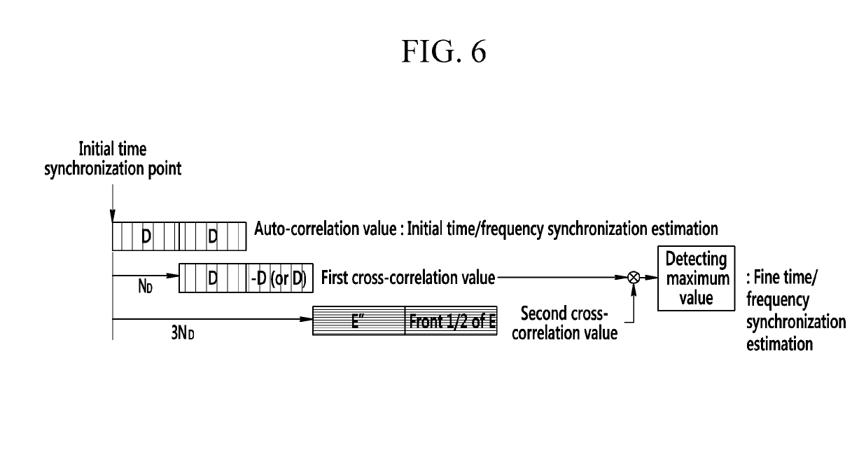

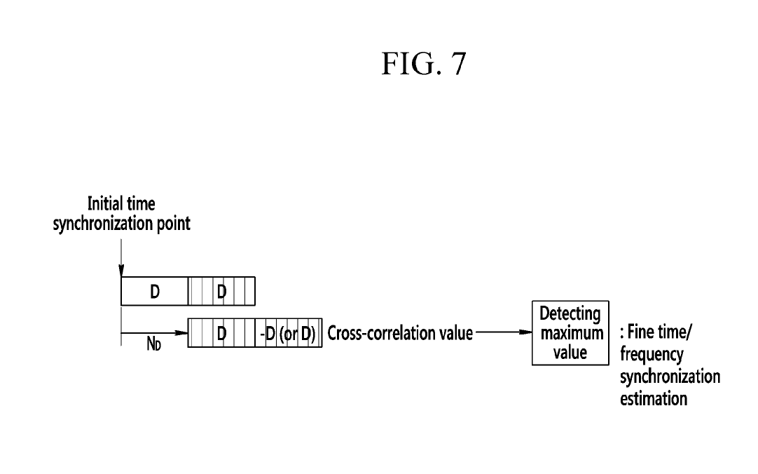

FIG. 5A and FIG. 5B are drawings illustrating a preamble according to an exemplary embodiment of the present invention, and FIG. 6 and FIG. 7 are schematic views illustrating a method for estimating time/frequency synchronization according to an exemplary embodiment of the present invention.

A terminal according to an exemplary embodiment of the present invention may perform automatic gain control, packet estimation, initial time/frequency synchronization, channel estimation, and collision detection using the preamble shown in FIG. 5A and FIG. 5B.

Referring to FIG. 5A and FIG. 5B, the time length of an STF 100 equals to that of two OFDM symbols, and includes five repetition patterns (D) 110. That is, in the repetition pattern 110 of the STF 100 according to an exemplary embodiment of the present invention shown in FIG. 5A and FIG. 5B, more samples than the number of repetition patterns of the STF shown in FIG. 4 may be included. In addition, the polarity of the last repetition pattern among the five repetition patterns included in the STF 100 may be reversed. The terminal according to an exemplary embodiment of the present invention may sense an end of the STF 100 through the last repetition pattern (−D) of which polarity is reversed. In an exemplary embodiment of the present invention, the time length of the repetition pattern 110 included in the STF 100 is N_{D}.

Meanwhile, the time length of the LTF 200 equals the time length of two valid OFDM symbols, and the LTF 200 includes two repetition patterns (E) 202 and the CP (E″) 201 of the repetition patterns. According to an exemplary embodiment of the present invention, E″ 201, the CP of the repetition pattern, is a long CP, and corresponds to a rear half of the repetition pattern E 202. Accordingly, the time length of the repetition pattern E 202 included in the LTF 200 according to an exemplary embodiment of the present invention equals ⅖ of the time length of an OFDM symbol.

First, a station terminal performs automatic gain control during the time (i.e., shorter than 2×N_{D}) of the first two (or the lesser) repetition patterns included in the STF 100. For example, the terminal may perform an operation (e.g., a mathematical addition or a mathematical average) that is predetermined for strength of the received signal or strength of the received power during the predetermined duration, and adjust the gain of an amplifier based on the acquired value as a result of the performance.

Later, the terminal acquires an initial time/frequency synchronization using the single auto-correlation method (refer to FIG. 2) (step of initial time/frequency synchronization). For example, first, the terminal calculates the result value R per sample during a predetermined window duration by multiplying the ‘conjugate signal(xₙ*)’ of the received sample signal by the ‘previous signal xₙ₋₁’ received prior to the received sample signal, and adding the result (xₙ*×xₙ₋₁) during the N_{D} duration. In this time, the result (xₙ*×xₙ₋₁) of the multiplication operation may be added according to FIFO (first in first out) during the N_{D} duration. In addition, if the size of the result value R per sample is smaller than a predetermined threshold value, the terminal determines there is no received signal (i.e., determines there is no received packet), and does not perform the initial time/frequency synchronization (step of packet estimation). That is, the terminal performs the initial time/frequency synchronization process below only if the size of the resulting value R per sample is greater than the predetermined threshold value.

Later, a sample time point having the greatest R among the resulting values R per sample may be determined to be an initial time synchronization point. Then, the terminal performs initial frequency synchronization using the phase of the result value R. That is, the terminal may estimate a frequency offset (i.e., a difference between transmitting/receiving carrier frequencies), and perform the frequency synchronization by applying the estimated frequency offset to the received signal.

Later, the terminal may perform fine time/frequency synchronization using the time/frequency synchronization method shown in FIG. 6. In an exemplary embodiment of the present invention, the fine time/frequency synchronization may be performed based on the cross-correlation value between the received sample signal x(k) and the repetition pattern (time domain signal) of a predefined preamble. First, the station terminal calculates the cross-correlation value between the conjugate of the sample signal (time domain) x(k) and the last two repetition patterns y(k) (k=0, 1, 2, . . . , 2(N_{D}/T_{S})−1) of the STF 100. According to an exemplary embodiment of the present invention, the cross-correlation value may be referred to as a first cross-correlation value, and the first cross-correlation value may be calculated during the time duration (i.e., 2×N_{D}) of the two repetition patterns of the STF 100 with respect to the repetition pattern y(k) started from a sample time point departed as much as N_{D} from the n^{th} sample x(k±n)* and the initial time synchronization point. The first cross-correlation value is shown in Equation 1.

|Σₖ₌₀^{2(N}^{_{D}}^{/T}^{_{S}}⁾⁻¹x*(k±n)y(k)| [Equation 1]

In Equation 1, T_{S} signifies the time length of a sample.

In the station terminal, the conjugate of the received sample signal x(k) and a second cross-correlation value of the repetition pattern of the LTF 200 are calculated. According to an exemplary embodiment of the present invention, the first cross-correlation value and the second cross-correlation value may be simultaneously calculated in parallel, and the repetition pattern of the LTF 200 may correspond to the repetition pattern as much as 2N_{D} departed as much as 3×N_{D} from the initial time synchronization point (i.e., first ½ of the repetition pattern E″ and E).

Next, for the n^{th} sample, a final cross-correlation value is obtained by multiplying the first cross-correlation value and the second cross-correlation value. Lastly, the station terminal finds the sample index of which the final cross-correlation value is the greatest using a peak detector, and determines the time point of the sample index to be the fine time synchronization point. Then, the station terminal may multiply the conjugate of the first cross-correlation value and the conjugate of the second cross-correlation value, and perform the fine frequency synchronization using the phase of the result of multiplying. That is, the station terminal may estimate a frequency offset based on the phase of the multiplication of the first cross-correlation value and the conjugate of the second cross-correlation value, and perform the fine frequency synchronization by applying the estimated frequency offset to the received signal.

The station terminal performs the channel estimation after performing the fine time/frequency synchronization. The channel estimation may be performed by removing a predetermined sequence after transforming the received signal to the signal of the frequency domain by applying the FFT and the like to the received signal of the time domain. In an exemplary embodiment of the present invention, the station terminal obtains a first signal for each available subcarrier by removing an LTF sequence of a certain frequency domain which is pre-allocated to a signal sequence to which the FFT or the discrete Fourier transform (DFT) is applied, for the first valid symbol duration after the fine time synchronization point (e.g., the first E of FIG. 5A and FIG. 5B). The station terminal obtains a second signal for each available subcarrier by removing the LTF sequence of the frequency domain from the signal sequence to which the FFT or the DFT is applied, for the second valid symbol duration (e.g., the second E of FIG. 5A and FIG. 5B). Subsequently, the station terminal calculates the channel estimation value for each subcarrier by adding the first signal and the second signal.

In the firstly proposed preamble structure, the matter to keep in mind is that additional time/frequency synchronization may be performed by applying the auto-correlation method of FIG. 2 for two repeated E durations of FIG. 5A and FIG. 5B. Referring to FIG. 7, the station terminal may perform only the fine time synchronization but may not perform the fine frequency synchronization after performing the initial fine time/frequency synchronization using the STF 100 of the preamble in FIG. 5A and FIG. 5B. In this time, the terminal may perform the fine time synchronization by calculating only the first cross-correlation value as shown in FIG. 6.

Again referring to FIG. 5A and FIG. 5B, the preamble according to an exemplary embodiment of the present invention includes a collision detection field (CDF) 300, and the CDF 300 includes at least one valid symbol duration R. Referring to FIG. 5A, the CDF 300 includes a plurality of valid symbol durations R, and the time length of each valid symbol duration corresponds to ⅘ of the time length of an OFDM symbol. Referring to FIG. 5B, a CDF 310 includes one valid symbol duration R, and R′ which is a CP of R, and the time length of the CDF 310 equals the time length of an OFDM symbol. In an exemplary embodiment of the present invention, the station terminal may detect a collision between messages using the CDFs 300 and 310, and accordingly, the capacity of overall system can be increased. According to an exemplary embodiment of the present invention, the terminal that wants resource allocation, search (discovery), association, etc. may carry a message notifying that the subject that transmits the preamble is its own through at least one subcarrier allocated independently (or randomly) for each terminal in the frequency domain of the valid symbol section included in the CDFs 300 and 310. At this time, the location of the message carried by the terminal and the location of subcarrier allocated to the terminal are the same within the CDFs 300 and 310. Referring to FIG. 5A, the station terminal may utilize one R among Rs of the CDF 300 as a CP duration for another R. That is, the station terminal may cope with the inter-symbol interference (ISI) using R located in the frontmost part of the CDF 300 as a guard interval. At this time, since a time length of R included in the CDF 300 is ⅘ of the time length of an OFDM symbol, one R may be longer than the long CP (e.g., E″). Accordingly, in an exemplary embodiment of the present invention, if a preamble transmitted from a specific terminal arrives at the station terminal at different times, the station terminal may cope with the time differences and detect the message transmitted from the specific terminal utilizing R located in the frontmost part among at least one R included in the CDF 300 as the CP.

Meanwhile, in another exemplary embodiment of the present invention, if the time difference of the preambles transmitted from different terminals arriving at the station terminal is small, the CDF 310 may include at least one valid symbol duration R and the short CP of R. Referring to FIG. 5B, the time length of the CDF 310 may be equal to the time length of an OFDM symbol, the length of one valid symbol duration R included in the CDF 310 may be 4T/5, and the length of R′ may be T/5.

According to a messaging method through the CDFs 300 and 310 of an exemplary embodiment of the present invention, a specific subcarrier may be allocated to each terminal, and each terminal may notify that the terminal is the subject that transmits the preamble by carrying a busy signal (or busy tone) of a physical layer that all terminals know in the allocated subcarrier. Referring to FIG. 5A and FIG. 5B, each of terminal 1 and terminal 2 transmits busy signals using two subcarriers, respectively.

In order for the terminal to transmit busy signals through the subcarrier of CDFs 300 and 310, first, each terminal divides available subcarriers by the number of subcarriers which are going to be utilized. In FIG. 5A and FIG. 5B, since each terminal utilizes two subcarriers, each terminal divides the available subcarriers into an upper subcarrier group and a lower subcarrier group. Next, each terminal independently (randomly) determines one subcarrier in the upper subcarrier group, and then determines one subcarrier in the lower subcarrier group. T this time, in order to estimate any changes in channels in the data section and to increase the channel estimation performance, a pilot may be allocated to a part of subcarriers among the subcarriers included in the preamble, and if the subcarrier chosen by the terminal is the subcarrier for the pilot, each terminal determines the subcarriers for a busy signal again. Further, each terminal allocates the busy tone known already to the selected subcarrier, and generates a valid symbol in the time domain by performing the FFT or DFT on the busy tone. The valid symbol R included in the busy tone may again be repeated in the time domain.

The terminal according to an exemplary embodiment of the present invention allocates a common sequence index to the STF 100 and LTF 200 included in the preamble, and transmits different CDFs 300 and 310 for each terminal. The terminal that receives the preamble may perform the automatic gain control, the packet estimation, the initial and fine time/frequency synchronization, and the channel estimation using the STF 100 and LTF 200 that are already known. Next, in the sample time point (in case of the CDF including one valid symbol, the sample time point of synchronized fine time which is the first part of the valid symbol) of the synchronized fine time that corresponds to the front part of the last valid symbol CDF 300 and 310, the terminal changes the received signal to the signal of frequency domain by performing the FFT or DFT. Then, the terminal counts the number of subcarriers that have a greater value than a threshold value by comparing the signal strength of each available subcarrier and the predetermined threshold value. Next, by comparing the number of subcarriers of which signal strength is greater than the threshold value and the number of subcarriers used for transmitting busy signals, whether the signal collision occurs can be determined. For example, in case each terminal transmits the busy signals using two subcarriers, the terminal that receives the preamble determines that no collision has occurred if the counted subcarriers are two or less, and determines that a collision has occurred if the counted subcarriers exceed two. Otherwise, in case each terminal transmits the busy signals using four subcarriers, the station terminal may determine that no collision has occurred if the counted subcarriers are five or less, and may determine that a collision has occurred if the counted subcarriers exceed five.

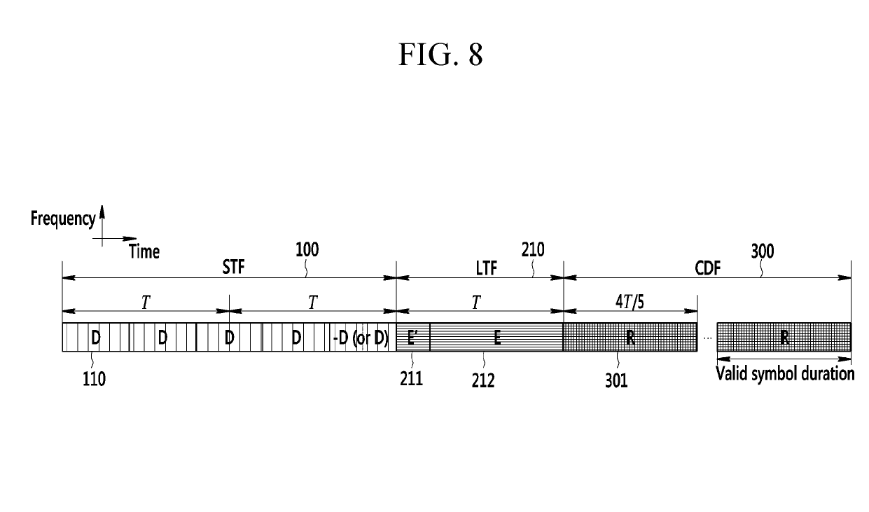

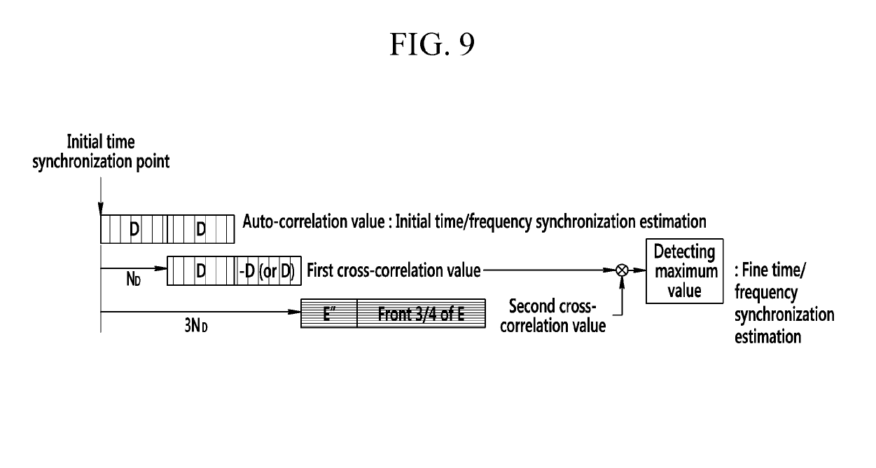

FIG. 8 is a drawing illustrating a preamble according to another exemplary embodiment of the present invention, and FIG. 9 is a schematic view illustrating a method for estimating time//frequency synchronization according to another exemplary embodiment of the present invention.

The terminal according to the current exemplary embodiment of the present invention may perform the automatic gain control, the packet estimation, the initial and fine time/frequency synchronization, the channel estimation, and the collision sensing.

Referring to FIG. 8, the preamble according to another exemplary embodiment of the present invention includes an STF 100, an LTF 210 and a CDF 300, and the time length of the LTF 210 in the preamble of FIG. 8, which is different from the preamble shown in FIG. 5A and FIG. 5B, is the same as the time length of an OFDM symbol. Further, the LTF 210 of FIG. 8 includes a repetition pattern E 212 and E′ 211 which is the CP of E. In this time, the CP E′ 211 corresponds to a latter ¼ of the repetition pattern E 212 as a short CP.

Referring to FIG. 9, the process of obtaining the first cross-correlation value is the same as that of FIG. 6, but the process of obtaining the second cross-correlation value is different from that of FIG. 6. That is, in the sample time point departed by as much as 3×N_{D} based on the initial time synchronization, the conjugate of the initial frequency synchronized sample signal x(k), the cross-correlation value of the CP signal E′ of the LTF 210, and the signal at a front ¾ point of the valid symbol may be calculated as the second cross-correlation value. In FIG. 9, since the part in which the CP of the time domain signal sequence E is included is used for the calculation of the second cross-correlation value, the estimated performance may be identical even if it is compared with FIG. 6. However, since the length of the LTF 210 becomes shorter than the preamble of FIG. 5A and FIG. 5B by ½, the channel estimation performance may be deteriorated. In order to prevent this, the terminal that receives the preamble of FIG. 8 generates a signal sequence by performing the FFT or DFT for the received signal, and performs the IFFT or IDFT for the signal sequence in which the LTF sequence is removed after removing the LTF sequence of the frequency domain which is already known in the generated signal sequence. In addition, the terminal allocates zero to the remainder part except for the signal sequence by as much as the time of CP of the LTF 210, and then calculates the final channel estimation value for each subcarrier by performing the FFT or DFT. The configuration and function of the CDF 300 are the same as that of the CDF 300 included in the preamble of FIG. 5A.

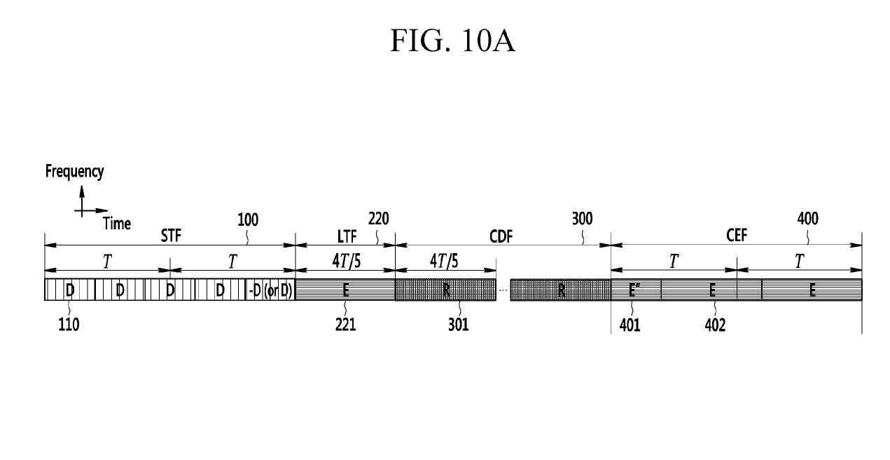

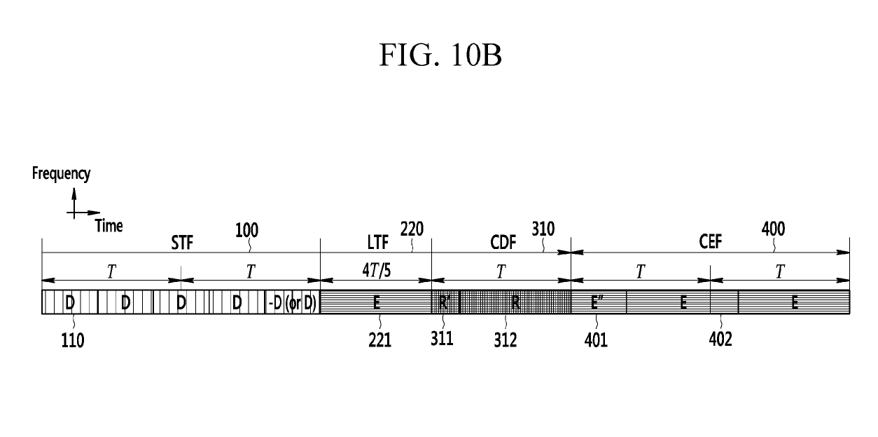

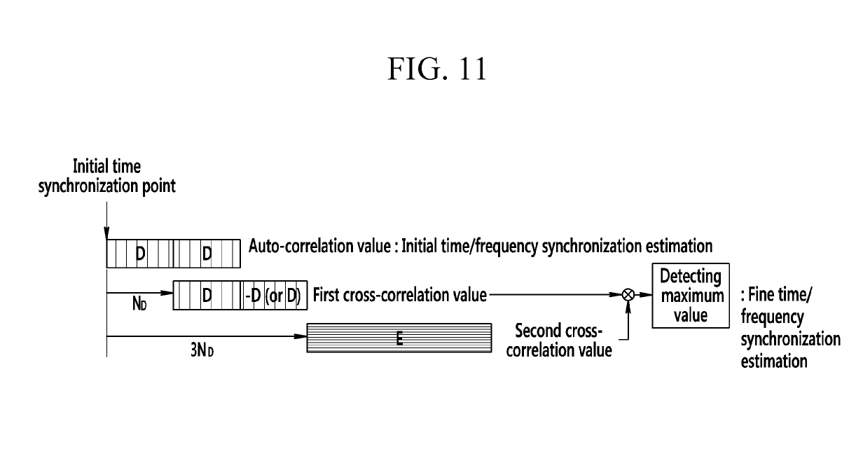

FIG. 10A and FIG. 10B are drawings illustrating a preamble according to another exemplary embodiment of the present invention, and FIG. 11 is a schematic view illustrating a method for estimating time//frequency synchronization according to another exemplary embodiment of the present invention.

Referring to FIG. 10A and FIG. 10B, a preamble according to the current embodiment of the present invention includes an STF 100, an LTF 220, CDFs 300 and 310, and a channel estimation field (CEF) 400. In FIG. 10A and FIG. 10B, the CDFs 300 and 310 may be located next to the LTF 220, and the CEF 400 may be located in connection with the CDFs 300 and 310. The CEF 400 includes at least one of valid symbol duration E 402 and a CP of E 401. In FIG. 10A and FIG. 10B, the time length of the LTF 220 is the same as that of ⅘ of the OFDM symbol, and accordingly, the second cross-correlation value may be calculated for the whole LTE 220. Referring to FIG. 11, a repetition pattern E 221 that occupies the whole of the LTF 220 may be used for calculation of the second cross-correlation value, and the terminal may perform the fine/frequency synchronization based on the first cross-correlation value and the second cross-correlation value. Then, in the preamble of FIG. 10A and FIG. 10B, the CEF 400 may play a role which is similar to that of the LTF 220. That is, the terminal that receives the preamble may perform the channel estimation or the fine time/frequency synchronization and the channel estimation. The difference between FIG. 10A and FIG. 10B is the CDFs 300 and 310, but the CDF 300 of FIG. 10A includes a plurality of repetition patterns R 301, and the time length of each repetition pattern 301 is the same as that of ⅘ OFDM symbol. On the other hand, the time length of the CDF 310 of FIG. 10B is the same as that of an OFDM symbol, and includes one repetition pattern R 312 and R′ 311 which is the CP of the repetition pattern R 312.

Referring to FIG. 11, although the procedure of obtaining the first cross-correlation value after the initial time/frequency synchronization is the same as that of FIG. 6, the second cross-correlation value is obtained by a different way than FIG. 6. That is, on the sample time point departed by as much as 3×N_{D} based on the initial time synchronization point, the cross-correlation value of the conjugate of the sample signal x(k) which is initially frequency synchronized and the valid symbol duration 221 signal of the LTF 220 may be calculated as the second cross-correlation value. Subsequently, the multiplication of the first cross-correlation value and second cross-correlation value may be determined as the final cross-correlation value, and the final cross-correlation value may be determined as the fine time synchronization point based on the largest time point.

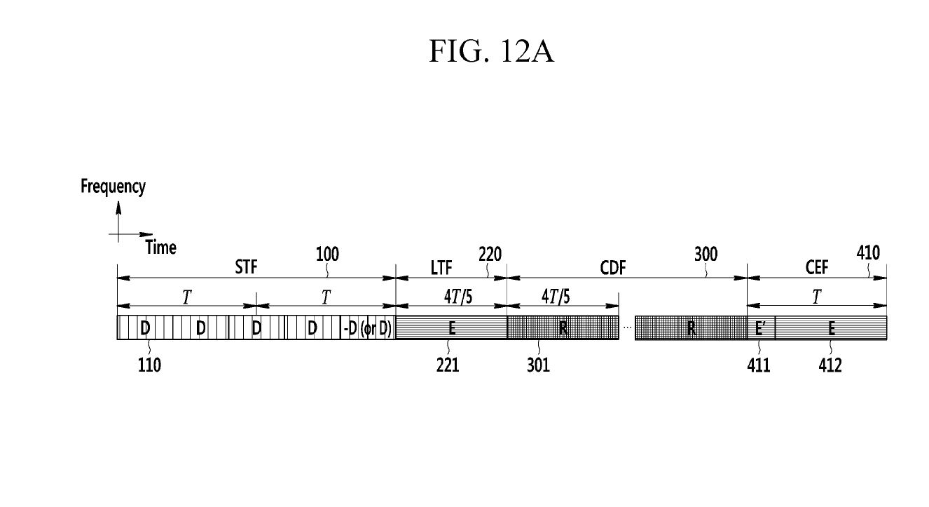

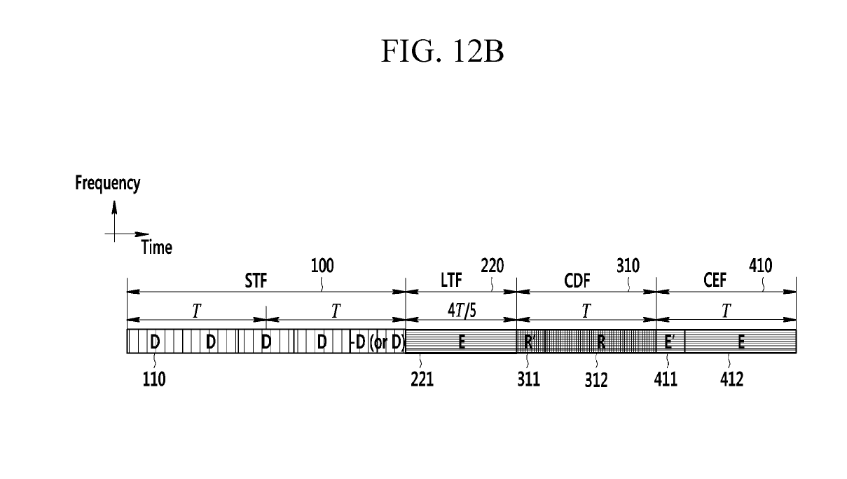

FIG. 12A and FIG. 12B are drawings illustrating a preamble according to another exemplary embodiment of the present invention.

Referring to FIG. 12A and FIG. 12B, the preamble according to the current exemplary embodiment of the present invention includes an STF 100, an LTF 220, CDFs 300 and 310, and a CEF 410. In the preamble of FIG. 12A and FIG. 12B, the time length of the LTF 220 equals ⅘ of the OFDM symbol, and includes one repetition pattern E 221. Further, the CDFs 300 and 310 includes a plurality of repetition patterns R (time length of ⅘ of the OFDM symbol) 301, or one repetition pattern R 312 and R′ 311, which is the CP of the repetition pattern R 312. The time length of the CEF equals one OFDM symbol, and includes the repetition pattern E 412 and E′ 411, which is the CP of the repetition pattern E 412. The terminal that receives the preamble shown in FIG. 12A or FIG. 12B may perform the automatic gain control, the packet estimation, and the initial time/frequency synchronization. The station terminal may perform the channel estimation only based on the CEF, or perform all of the fine time/frequency synchronization and the channel estimation. The role of CDFs 300 and 310 is the same as that of the CDF 300 and 310 shown in FIG. 5A and FIG. 5B.

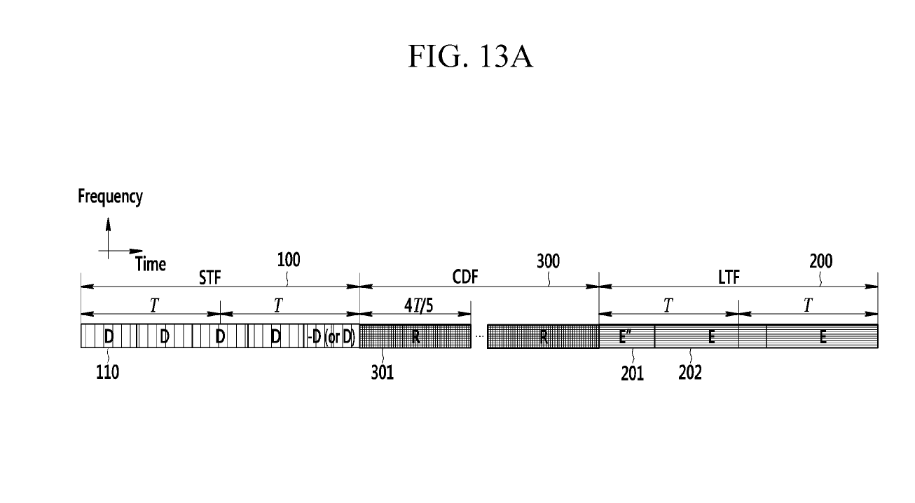

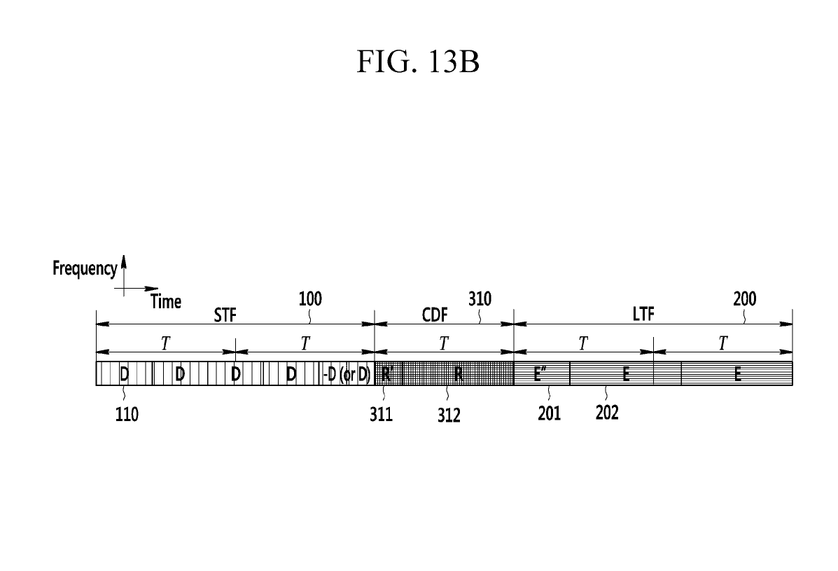

FIG. 13A and FIG. 13B are drawings illustrating a preamble according to another exemplary embodiment of the present invention.

Referring to FIG. 13A and FIG. 13B, the preamble according to the current exemplary embodiment of the present invention includes an STF 100, an LTF 200 and CDFs 300 and 310. The CDFs 300 and 310 may be located between the STF 100 and the LTF 200. The STF 100 and the LTF 200 of the preamble shown in FIG. 13A and FIG. 13B are the same as the STF 100 and the LTF 200 of the preamble shown in FIG. 5A and FIG. 5B. Accordingly, the terminal may perform the automatic gain control, the packet estimation, the initial time/frequency synchronization, and the channel estimation using the STF 100 and the LTF 200 of the preamble shown in FIG. 13A and FIG. 13B using the same method shown in FIG. 6. In addition, the terminal may perform the collision sensing the same as the case of the preamble of FIG. 5A and FIG. 5B using the CDFs 300 and 310 of the preamble shown in FIG. 13A and FIG. 13B.

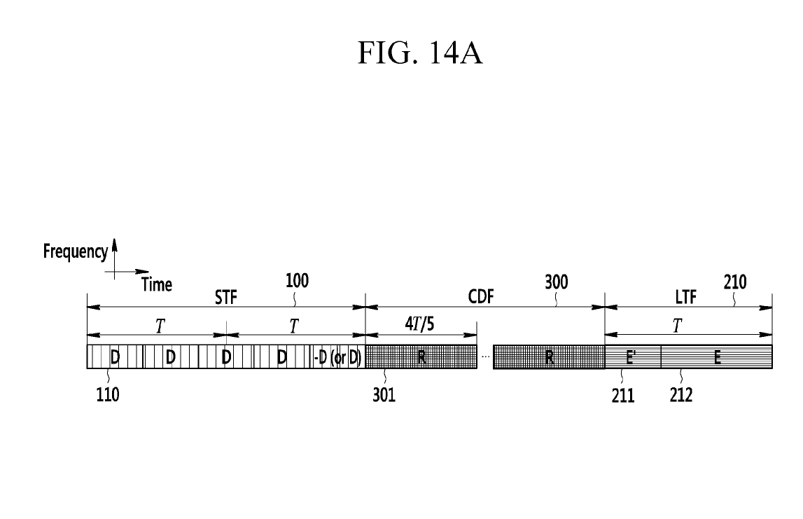

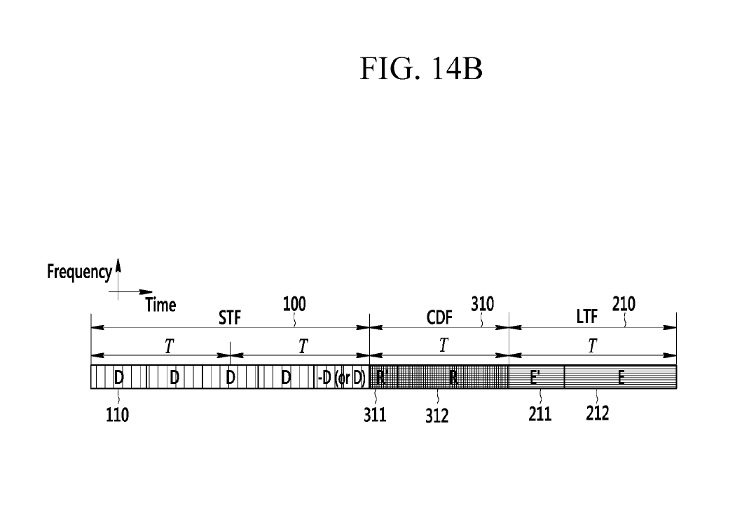

FIG. 14A and FIG. 14B are drawings illustrating a preamble according to another exemplary embodiment of the present invention.

Referring to FIG. 14A and FIG. 14B, the preamble according to the current exemplary embodiment of the present invention includes an STF 100, an LTF 210, and CDFs 300 and 310. The CDFs 300 and 310 may be located between the STF 100 and the LTF 210, and the time length of the LTF 210 is equal that of one OFDM symbol. That is, the STF 100 and the LTF 210 shown in FIG. 14A and FIG. 14B are identical to the STF 100 and the LTF 210 of the preamble shown in FIG. 8. Accordingly, the terminal may perform the automatic gain control, the packet estimation, the initial and fine time/frequency synchronization, and the channel estimation using the STF 100 and the LTF 210 of the preamble shown in FIG. 14A and FIG. 14B using the same method shown in FIG. 9. In addition, the terminal may perform the collision sensing the same as the case of the preamble of FIG. 5A and FIG. 5B using the CDFs 300 and 310 of the preamble shown in FIG. 14A and FIG. 14B.

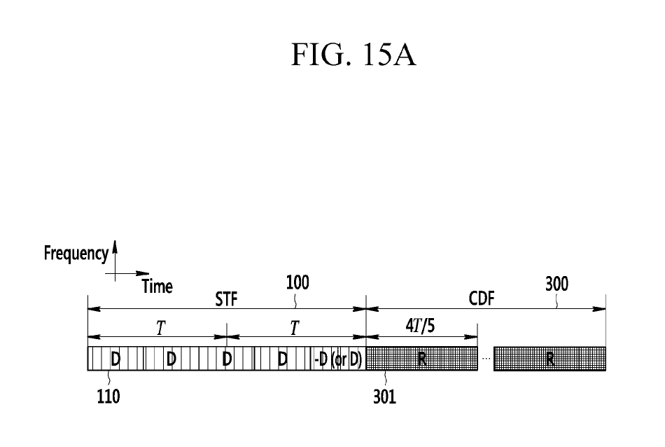

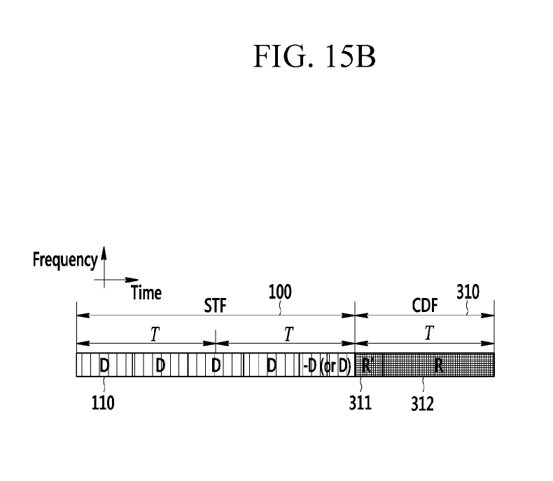

FIG. 15A and FIG. 15B are drawings illustrating a preamble according to another exemplary embodiment of the present invention.

Referring to FIG. 15A and FIG. 15B, the preamble according to the current exemplary embodiment of the present invention includes an STF 100 and CDFs 300 and 310. That is, in the preamble shown in FIG. 15A and FIG. 15B, an LTF is not included, and the STF 100 and the CDFs 300 and 310 shown in FIG. 15A and FIG. 15B are identical to the STF 100 of the preamble shown in FIG. 5A and FIG. 5B. Accordingly, the station terminal may perform the fine time synchronization using the STF 100 of the preamble shown in FIG. 15A or FIG. 15B using the same method shown in FIG. 7. Further, the terminal may perform the code reversal for the time domain signal of the repetition pattern after the N_{D} time on the fine time synchronization point, and after performing the FFT or the DFT on the fine time synchronization point, may determine the result value for each subcarrier obtained by removing the sequence component as the channel estimation value. At this time, if a pilot subcarrier is included in the CDFs 300 and 310 of the preamble shown in FIG. 15A and FIG. 15B, the terminal may more finely estimate the channel using the pilot subcarrier included in the CDFs 300 and 310.

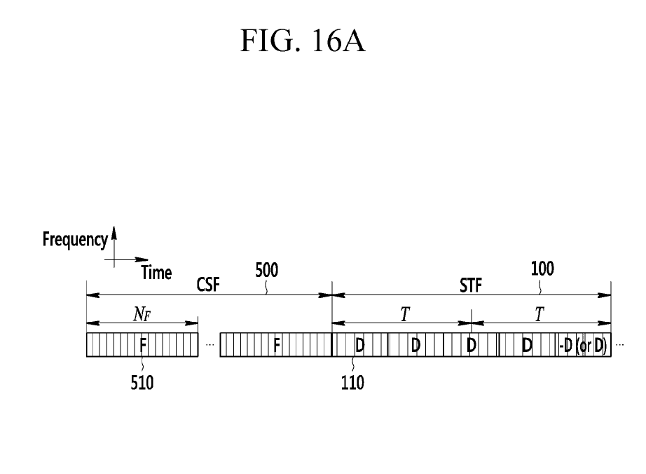

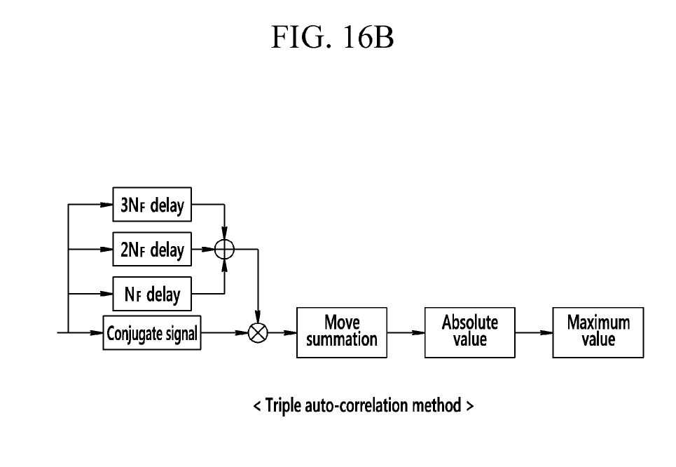

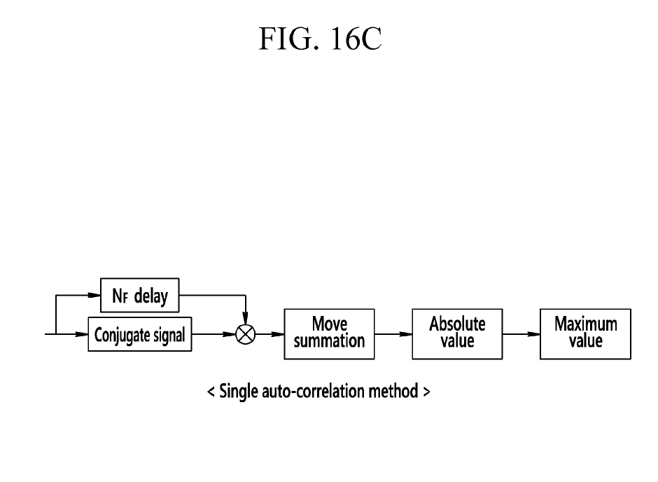

FIG. 16A, FIG. 16B, and FIG. 16C are drawings illustrating a method for sensing a preamble and a carrier according to another exemplary embodiment of the present invention.

Referring to FIG. 16A, the preamble according to the current exemplary embodiment of the present invention includes an STF 100 and a carrier sensing field (CSF) 500 located in the front part of the STF 100. The station terminal may perform the automatic gain control, the packet estimation, the initial and fine time/frequency synchronization, the channel estimation, the collision sensing, and the carrier sensing (CS) through the preamble shown in FIG. 16A.

In another exemplary embodiment of the present invention, an object of the CSF 500 is to solve the hidden terminal problem by enhancing the carrier sensing and to increase the system capacity such that the station terminal located in a region beyond the general carrier sensing range can also be sensed. In FIG. 16A, the STF 100 is located at the rear of the CSF 500, but the automatic gain control may be performed before the carrier sensing is performed. Referring to FIG. 16A, N_{F} represents the time length of one repetition pattern F 510 included in the CSF 500. In another exemplary embodiment of the present invention, the repetition pattern F 510 included in the CSF 500 may be configured by two methods. First, one repetition pattern 510 may be configured based on one signal (or sequence). Second, a small repetition pattern F′ may be configured based on one signal (sequence), and one repetition pattern F may be configured through the combination of F′. For example, the repetition pattern F included in the CSF may be configured by Equation 2 below.

F=(F′,−F′) or (F′, F′, −F′, −F′) [Equation 2]

At this time, the one signal (or sequence) configuring the repetition pattern F 510 included in the CSF 500 may be equal to one signal (or sequence) configuring the repetition pattern D 110 included in the STF 100, but the length of the sequence may be different. Alternatively, the one signal (or sequence) configuring the repetition pattern F 510 included in the CSF 500 may be different from one signal (or sequence) configuring the repetition pattern D 110 included in the STF 100, and the length of the sequence may also be different.

Referring to FIG. 16B, the station terminal may perform the carrier sensing through the combination of an energy estimation technique and a multiple auto-correlation technique. In FIG. 16B, first, the terminal determines the carrier to be sensed if the size of energy of the received signal estimated by the energy estimation technique exceeds a first threshold value which is predetermined. However, if the estimated size of energy is the same as or smaller than the first threshold value which is predetermined, the station terminal may determine whether to perform the carrier sensing by comparing the size of the correlation value (e.g., the multiplication of the conjugate value of the received signal with the addition of signals each delayed by as much as N_{F}, 2N_{F}, and 3N_{F}) which is obtained from the CSF through a triple auto-correlation method with the second threshold value which is predetermined. That is, the station terminal may determine the carrier to be sensed if the correlation value of the triple auto-correlation is greater than the second threshold value, and determine the carrier to not be sensed if the correlation value is the same as or smaller than the second threshold value.

Referring to FIG. 16C, the preamble according to the current exemplary embodiment of the present invention also includes an STF 100 and a CSF which is located at the front part of the STF 100. Through the CSF of FIG. 16C, the terminal located on a point that exceeds a common carrier sensing range may perform the carrier sensing and the automatic gain control. At this time, the station terminal may selectively perform the automatic gain control. In another exemplary embodiment of the present invention, the station terminal may determine the carrier to be sensed if the energy estimation value obtained using the energy estimation technique exceeds a third threshold value which is predetermined. However, if the energy estimation value is not greater than the third threshold value which is predetermined, the station terminal may determine whether to perform the carrier sensing by comparing the size of correlation value (e.g., the multiplication of the conjugate of the received signal and the signal delayed by as much as NF) which is obtained through the single auto-correlation method with the fourth threshold value which is predetermined. That is, if the correlation value of the single auto-correlation is greater than the fourth threshold value, the station terminal may determine the carrier to be sensed, and if the correlation value is the same as or smaller than the fourth threshold value, may determine the carrier to not be sensed.

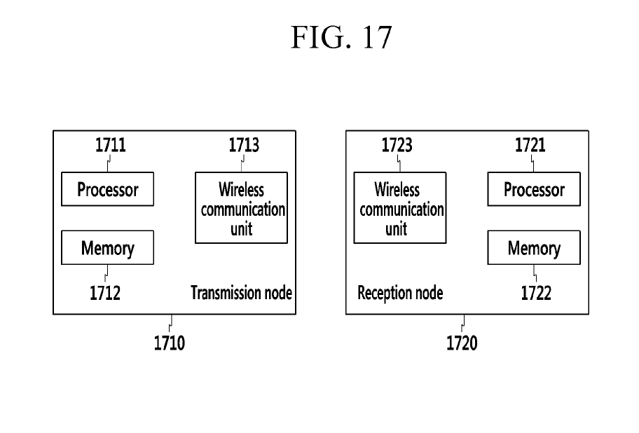

FIG. 17 is a block diagram illustrating a wireless communication system according to another exemplary embodiment of the present invention.

Referring to FIG. 17, the wireless communication system according to an exemplary embodiment of the present invention includes a transmitting terminal 1710 and a station terminal 1720.

The transmission terminal 1710 includes a processor 1711, a memory 1712, and a radio frequency (RF) unit 1713. The memory 1712 may be connected to the processor 1711, and may store various information to drive the processor 1711. The RF unit 1713 may be connected to the processor 1711 and transmit/receive wireless signals. The processor 1711 may be implemented as the function, process, or method proposed by an exemplary embodiment of the present invention. In a wireless communication system according to an exemplary embodiment of the present invention, the wireless interface protocol layer may be implemented by the processor 1711. The operation of the transmitting terminal 1710 according to an exemplary embodiment of the present invention may be implemented by the processor 1711.

The station terminal 1720 includes a processor 1721, a memory 1722, and an RF unit 1723. The memory 1722 may be connected to the processor 1721, and may store various information to drive the processor 1721. The RF unit 1723 may be connected to the processor 1721 and transmit/receive wireless signals. The processor 1721 may be implemented as the function, process, or method proposed by an exemplary embodiment of the present invention. In a wireless communication system according to an exemplary embodiment of the present invention, the wireless interface protocol layer may be implemented by the processor 1721. The operation of the station terminal 1720 according to an exemplary embodiment of the present invention may be implemented by the processor 1721.

In an exemplary embodiment of the present invention, the memory may be located inside or outside of the processor, and the memory may be connected to the processor through various means already known. The memory is a volatile or nonvolatile storage medium of various forms, and for example, the memory may include a read-only memory (ROM) or a random access memory (RAM).

As such, using the preamble according to an exemplary embodiment of the present invention, a station terminal may perform the collision sensing of signals and the carrier sensing of a wide range as well as the high performance time/frequency synchronization. Accordingly, overall system capacity of communication systems among terminals can be maximized.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method for transmitting a preamble by a terminal, comprising
transmitting the preamble to a neighboring terminal located around the terminal,
wherein the preamble includes a short training field (STF) including five repetition patterns, and a time length of the STF equals a time length of two orthogonal frequency division multiplexing (OFDM) symbols.

2. The method for transmitting preamble of claim 1, wherein a polarity of a last repetition pattern among the five repetition patterns is different from a polarity of remaining four repetition patterns.

3. The method for transmitting preamble of claim 1, wherein the preamble further includes a long training field (LTF) used in fine synchronization, wherein the LTF has a time length that equals a time length of two OFDM symbols, and includes two first valid symbol durations and a first cyclic prefix of the first valid symbol duration, and wherein the first cyclic prefix corresponds to a last ½ of the first valid symbol duration.

4. The method for transmitting preamble of claim 1, wherein the preamble further includes a long training field (LTF) used in fine synchronization, wherein the LTF has a time length that equals a time length of two OFDM symbols, and includes one first valid symbol duration and a first cyclic prefix of the first valid symbol duration, and wherein the first cyclic prefix corresponds to a last ¼ of the first valid symbol duration.

5. The method for transmitting preamble of claim 1, wherein the preamble further includes a long training field (LTF) used in fine synchronization, wherein the LTF includes one first valid symbol duration, and wherein a time length of the first valid symbol duration equals to ⅘ of a time length of the OFDM symbol.

6. The method for transmitting preamble of claim 1, wherein the preamble further includes a collision detection field (CDF) used for collision sensing among messages, wherein the CDF has a time length that equals a time length of an OFDM symbol, and includes one second valid symbol duration and a second cyclic prefix of the second valid symbol duration, and wherein the second cyclic prefix corresponds to a last ¼ of the second valid symbol duration.

7. The method for transmitting preamble of claim 1, wherein the preamble further includes a collision detection field (CDF) used for collision sensing among messages, wherein the CDF includes at least one valid symbol duration, and wherein a time length of the at least one valid symbol duration equals ⅘ of a time length of the OFDM symbol.

8. The method for transmitting preamble of claim 1, wherein the preamble further includes a long training field (LTF) used in fine synchronization and a collision detection field (CDF) used for collision sensing among messages, wherein the LTF is located next to the STF, and wherein the CDF is located next to the LTF.

9. The method for transmitting preamble of claim 1, wherein the preamble further includes a long training field (LTF) used in fine synchronization and a collision detection field (CDF) used for collision sensing among messages, wherein the CDF is located next to the STF, and wherein the LTF is located next to the CDF.

10. The method for transmitting preamble of claim 8, wherein the preamble further includes a channel estimation field (CEF) used for channel estimation, and wherein the CEF is located next to the CDF.

11. The method for transmitting preamble of claim 1, wherein the preamble further includes a channel sensing field (CSF) used for carrier sensing, and wherein the CSF is located at a front part of the STF.

12. A method for receiving a preamble by a terminal, comprising:
receiving a signal from a neighboring terminal located around the terminal; and
performing time and frequency synchronization with the signal using a repetition pattern included in a preamble.

13. The method for receiving a preamble of claim 12, wherein performing the time and frequency synchronization further includes:
calculating an auto-correlation value of a conjugate signal of the signal and a previous signal received prior to the signal; and
determining an initial time synchronization point based on the auto-correlation value.

14. The method for receiving a preamble of claim 13, wherein performing the time and frequency synchronization further includes:
calculating a first cross-correlation value for a repetition pattern included in the conjugate signal and a short training field (STF) of the preamble;
calculating a second cross-correlation value for a repetition pattern included in the conjugate signal and a long training field (LTF) of the preamble; and
determining a final time synchronization point by calculating a final correlation value based on the first cross-correlation value and the second cross-correlation value, and based on the final cross-correlation value.

15. A terminal transmitting a preamble, comprising:
at least one processor;
a memory; and
a wireless communication unit,
by operating at least one program stored in the memory, wherein the at least one processor performs
transmitting the preamble to a neighboring terminal located around the terminal,
wherein the preamble includes a short training field (STF) including five repetition patterns, and a time length of the STF equals a time length of two orthogonal frequency division multiplexing (OFDM) symbols.

16. The terminal of claim 15, wherein the preamble further includes a long training field (LTF) used in fine synchronization, wherein the LTF has a time length that equals a time length of two OFDM symbols, and includes two first valid symbol durations and a first cyclic prefix of the first valid symbol duration, and wherein the first cyclic prefix corresponds to a last ½ of the first valid symbol duration.

17. The terminal of claim 15, wherein the preamble further includes a long training field (LTF) used in fine synchronization, wherein the LTF has a time length that equals a time length of two OFDM symbols, and includes one first valid symbol duration and a first cyclic prefix of the first valid symbol duration, and wherein the first cyclic prefix corresponds to a last ¼ of the first valid symbol duration.

18. The terminal of claim 15, wherein the preamble further includes a long training field (LTF) used in fine synchronization, wherein the LTF includes one first valid symbol duration, and wherein a time length of the first valid symbol duration equals ⅘ of a time length of the OFDM symbol.

19. The terminal of claim 15, wherein the preamble further includes a collision detection field (CDF) used for collision sensing among messages, wherein the CDF has a time length that equals a time length of an OFDM symbol, and includes one second valid symbol duration and a second cyclic prefix of the second valid symbol duration, and wherein the second cyclic prefix corresponds to a last ¼ of the second valid symbol duration.

20. The terminal of claim 15, wherein the preamble further includes a long training field (LTF) used in fine synchronization and a collision detection field (CDF) used for collision sensing among messages, wherein the CDF is located next to the STF, and wherein the LTF is located next to the CDF.
